(19) United States
(12) Patent Application Publication
(10) Pub. No.: US 2014/0197041 A1
(43) Pub. Date: Jul. 17, 2014

(54) AMPEROMETRIC BIOSENSOR AND DETECTING METHOD USING THE SAME

(71) Applicant: National Chi Nan University, Puli, Nantou (TW)

(72) Inventors: Tak-Shing CHING, Taichung City (TW); Tai-Ping SUN, Jhongli City, Taoyuan County (TW); Jyun-Jhih WANG, Puli, Nantou (TW)

(21) Appl. No.: 13/936,566

(22) Filed: Jul. 8, 2013

(30) Foreign Application Priority Data
Jan. 16, 2013 (TW) 102101620

(51) Int. Cl. G01N 27/327

(52) U.S. Cl. CPC G01N 27/3271
USPC 205/777.5; 204/403.14; 29/825

(57) ABSTRACT

An amperometric biosensor is adapted for detecting concentration of a target analyte, and includes a detector and a plurality of sensing members connected electrically to form an input of the detector. Each sensing member includes an electrode unit including a working electrode with a biorecognition element disposed thereon for reaction with the target analyte, and a reference electrode. Each sensing member receives the target analyte, so as to bring the target analyte into contact with the working and reference electrodes. The detector provides a voltage to each electrode unit, so as to generate a current that flows through the target analyte and that is detected for subsequent concentration analysis of the target analyte.

### CROSS-REFERENCE TO RELATED APPLICATION

This application claims priority to Taiwanese Application No. 102101620, filed on Jan. 16, 2013.

### BACKGROUND OF THE INVENTION

1. Field of the Invention

The invention relates to a biosensor, and more particularly to an amperometric biosensor and a detecting method using the same.

2. Description of the Related Art

A biosensor is a device that employs biological elements and physical/chemical detection techniques for analysis and detection of a target analyte, and includes a biorecognition element and a signal converter. The biorecognition element may be an enzyme, an antibody, a nucleic acid or a microorganism which is a biochemical substance with substance specificity. The biorecognition element is reactive to the corresponding target analyte and thus generate a signal, which may be a current signal, a chemical fluorescence, heat, sound wave, etc. The signal converter is used to convert such a signal into a form suitable for analysis and statistics by a detector.

Common biosensors include amperometric biosensors, optic-fiber biosensors, piezoelectric quartz crystal biosensors, etc. The amperometric biosensors use electric signals for determination and analysis of concentration of the target analyte, and more particularly observe current variation during the biochemical reaction of the target analyte and the biorecognition element. In some cases, current variation is proportional to concentration of the target analyte, so that the concentration of the target analyte may be derived using a relevant equation.

Electrochemical analysis methods are advantageous in terms of high sensitivity, good selectivity, capability for multi-analysis and species identification, etc. Therefore, biosensors are commonly applied to medical detection in recent years. As an example, urea concentration, which serves as an index of the renal function, is detected in a blood serum or in urine using the biosensor. Medication or food control may be provided accordingly.

Conventional medical biosensors are expensive, and complicated operation steps thereof can only be performed by skilled operators. In addition, the size of the detecting instrument is not suitable for household applications.

### SUMMARY OF THE INVENTION

Therefore, an object of the present invention is to provide an amperometric biosensor with high sensitivity and a small size.

According to one aspect of the present invention, an amperometric biosensor is adapted for detecting concentration of a target analyte, and comprises a detector and a plurality of sensing members that are connected electrically to form an input of the detector.

Each of the sensing members includes an insulator substrate and an electrode unit disposed on the insulator substrate.

The electrode unit includes a working electrode with a biorecognition element disposed thereon for reaction with the target analyte, and a reference electrode spaced apart from the working electrode.

Each of the sensing members is adapted to receive the target analyte, so as to bring the target analyte into contact with at least a portion of the working electrode and at least a portion of the reference electrode.

The detector is configured to provide the working electrode and the reference electrode of each of the sensing members with a predetermined voltage therebetween, so as to generate a current that flows through the target analyte received by each of the sensing members.

The detector is further configured to detect the currents generated by the sensing members for subsequent concentration analysis of the target analyte.

Another object of the present invention is to provide a method for manufacturing an amperometric biosensor of this invention with a relatively low cost.

According to another aspect of the present invention, there is provided a method for manufacturing an amperometric biosensor for sensing concentration of a target analyte. The method comprises:

a) providing a plurality of insulator substrates each having an electrode unit disposed thereon, wherein the electrode unit includes a working electrode and a reference electrode spaced apart from the working electrode;

b) disposing a blocking member on each of the insulator substrates in a manner that the reference electrode is not covered thereby and that the blocking member surrounds a portion of the working electrode, the blocking member being formed with an opening that exposes said portion of the working electrode, and cooperating with the insulator substrate to define a space;

c) introducing a biorecognition element that is reactive to the target analyte into the space defined in step b), so as to dispose the biorecognition element on a surface of said portion of the working electrode that is exposed from the opening of the blocking member; and

d) connecting electrically the electrode units to each other.

Yet another object of the present invention is to provide a method for detecting concentration of a target analyte.

According to yet another aspect of the present invention, there is provided a method for detecting concentration of a target analyte, which comprises:

a) connecting electrically a plurality of sensing members to form an input of a detector, wherein each of the sensing members includes an insulator substrate and an electrode unit disposed on the insulator substrate, the electrode unit including a working electrode with a biorecognition element disposed thereon for reaction with the target analyte, and a reference electrode spaced apart from the working electrode;

b) introducing the target analyte to each of the sensing members, so as to bring the target analyte into contact with at least a portion of the working electrode and at least a portion of the reference electrode of each of the sensing members;

c) configuring the detector to provide a predetermined voltage between the working electrode and the reference electrode of each of the sensing members, so as to generate a current flowing through the target analyte introduced to each of the sensing members; and

d) configuring the detector to detect the currents generated in step c) for subsequent concentration analysis of the target analyte.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic diagram illustrating a preferred embodiment of the amperometric biosensor according to the present invention;

FIG. 2 is a perspective exploded view of a sensing member of the preferred embodiment;

FIG. 3 is a flow chart illustrating steps of a method for manufacturing the preferred embodiment and the subsequent detection using the preferred embodiment;

FIG. 4 is a plot showing a current measurement result using single-sensing configuration;

FIG. 5 is a plot showing a relationship between the current measured using single-sensing configuration and concentration of uric acid;

FIG. 6 is a plot showing a current measurement result using dual-sensing configuration;

FIG. 7 is a plot showing a relationship between the current measured using dual-sensing configuration and concentration of uric acid;

FIG. 8 is a plot to compare current measurements using single-sensing configuration and multi-sensing configuration; and

FIG. 9 is a histogram showing differences of signal-to-noise ratios between measurements using single-sensing configuration and multi-sensing configuration.

### DETAILED DESCRIPTION OF THE PREFERRED EMBODIMENT

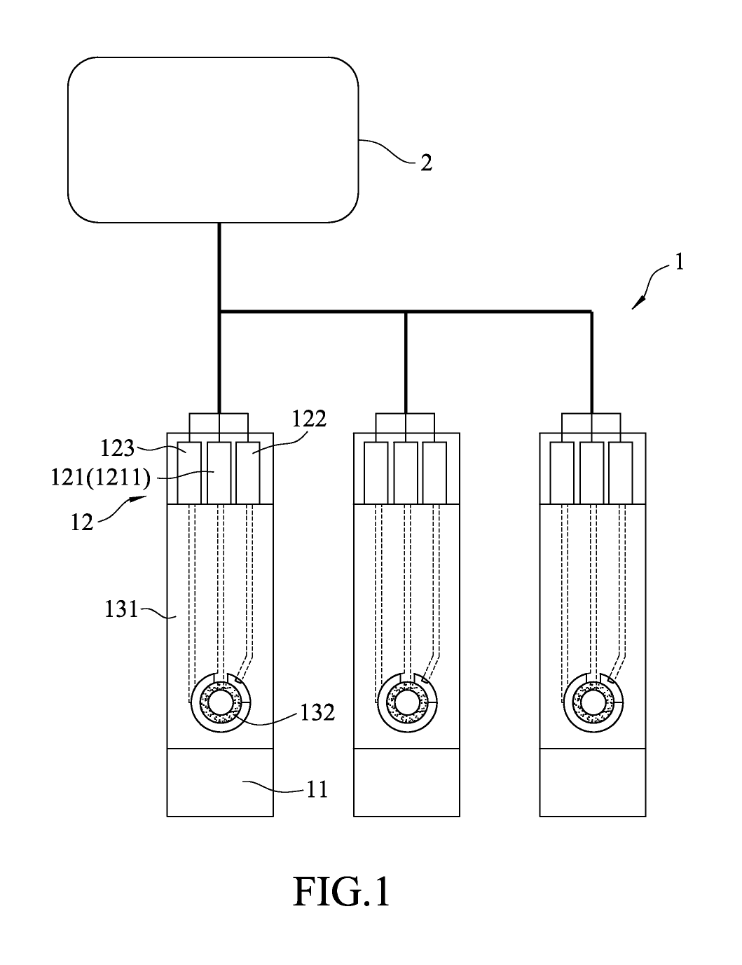

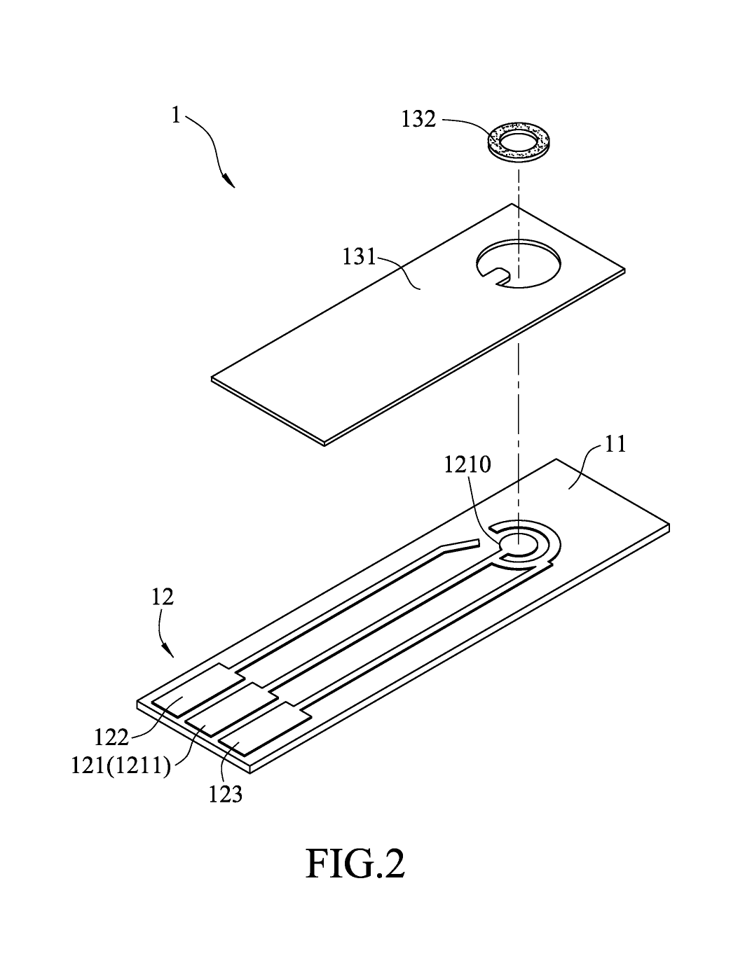

Referring to FIGS. 1 and 2, the preferred embodiment of the amperometric biosensor according to this invention is shown to include a plurality of sensing members 1 and a detector 2 for detecting concentration of a target analyte. The sensing members 1 are connected electrically to form an input of the detector 2.

In the preferred embodiment, the amperometric biosensor includes three sensing members 1. Each sensing member 1 includes an insulator substrate 11, an electrode unit 12 disposed on the insulator substrate 11, a limiting member 131 and a blocking member 132. The electrode unit 12 includes a working electrode 121, a reference electrode 122 spaced apart from the working electrode 121, and a counter electrode 123 coupled to the working electrode 121.

The working electrode 121 may be made of materials selected from platinum, gold, carbon and mercury, and, in this embodiment, has a reaction portion 1210 with a biorecognition element disposed thereon, and a connecting portion 1211 for connection with the detector 2. In this embodiment, glutaraldehyde is used as a cross-linking agent for linkage between the biorecognition element and a surface of the working electrode 121, and the biorecognition element is an enzyme reactive to the target analyte. Aldehyde group of the glutaraldehyde reacts with amino group of the enzyme to generate links, which fix the enzyme on the surface of the working electrode 121, so as to minimize loss of the enzyme during reaction with the target analyte. Reaction products of the target analyte and the enzyme will generate oxidation current when a voltage is applied to the electrode unit 12. The oxidation current is outputted from the working electrode 121, and different concentrations result in different magnitudes of the oxidation current.

The reference electrode 122 is coupled to a voltage source (e.g., the detector 2) to hold a stable electric potential thereon. The electric potential at the reference electrode 122 is not affected by the concentration of the target analyte and the electric potential at the working electrode 121. The reference electrode 122 is generally selected from a mercury electrode, a mercurous chloride electrode, and a Ag/AgCl electrode.

When the current generated during reaction of the target analyte and the biorecognition element is too large, the electric potential at the working electrode 121 may deviate. The counter electrode 123 is used for stabilization of the electrical potential at the working electrode 121. The counter electrode 123 may be made of a material selected from silver, nickel, platinum and carbon.

The limiting member 131 is made of an insulating material, and is disposed on the insulator substrate 11. The limiting member 131 is formed with an opening to expose the reaction portion 1210 of the working electrode 121 and a portion of the reference electrode 122, and cooperates with the insulator substrate 11 to define a space for receiving the target analyte.

The blocking member 132 is disposed on the insulator substrate 11 in a manner that said portion of the reference electrode 122 is not covered thereby and that the blocking member 132 surrounds the reaction portion 1210 of the working electrode 121. The blocking member 132 is formed with an opening that exposes the reaction portion 1210 of the working electrode 121 for receiving the cross-linking agent and the biorecognition element.

In this embodiment, the working electrode 121, the reference electrode 122 and the counter electrode 123 are formed on a surface of the insulator substrate 11 using screen printing. Each of the working electrode 121 and the counter electrode 123 is made of a carbonic material, and the reference electrode 122 is an Ag/AgCl electrode.

In this embodiment, the electrode units 12 of the sensing members 1 are electrically connected in parallel. In detail, the working electrodes 121 of the electrode units 12 of the sensing members 1 are electrically interconnected, and the reference electrodes 122 of the electrode units 12 of the sensing members 1 are electrically interconnected. The detector 2 is used to detect the currents outputted from the working electrodes 121 and makes a data record thereof. The detector 2 may determine concentration of the target analyte using an electrochemical analysis method. A relationship between current and time (e.g., i-t curve) may be obtained by measuring variation of the oxidation current after reaction of the target analyte and the biorecognition element. In this embodiment, variation of the oxidation current is proportional to the concentration of the target analyte, so that the concentration of the target analyte can be derived.

In this invention, since the sensing members 1 are electrically connected to each other, signal strength (i.e., current received by the detector 2) is thus promoted, resulting in a higher signal-to-noise ratio (SNR).

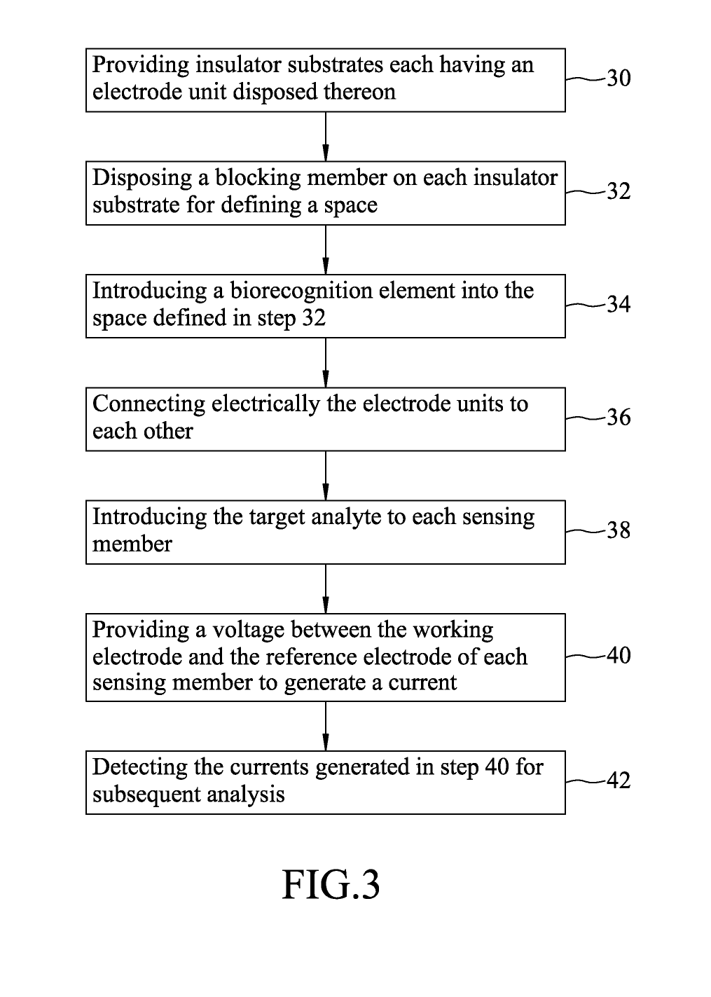

The amperometric biosensor of this invention may be manufactured and used with the following steps as shown in FIG. 3.

Step 30: A plurality of insulator substrates 11 are provided. Each insulator substrate 11 has an electrode unit 12 disposed thereon, and the electrode unit 12 includes a working electrode 121, a reference electrode 122, and a counter electrode 123 that are spaced apart from each other.

Step 32: A blocking member 132 is disposed on each of the insulator substrates 11 in a manner that the reference electrode 122 is not covered thereby and that the blocking member 132 surrounds a reaction portion 1210 of the working electrode 121. The blocking member 132 is formed with an opening that exposes the reaction portion 1210 of the working electrode 121, and cooperates with the insulator substrate 11 to define a space.

Step 34: A biorecognition element (enzyme) that is reactive to the target analyte is introduced into the space defined in step 32, so as to dispose the biorecognition element on a surface of the reaction portion 1210 of the working electrode 121 that is exposed from the opening of the blocking member 132. In detail, a cross-linking agent (glutaraldehyde) is first introduced into the space defined in step 32 to cover a surface of the reaction portion 1210 of the working electrode 121. Then, step 34 is performed to introduce the biorecognition element on the surface having the cross-linking agent disposed thereon to cause a cross-linking reaction, so that the biorecognition element is fixed on the surface of the reaction portion 1210 of the working electrode 121.

Step 36: The electrode units 12 are electrically connected to each other, and the electrode units 12 are electrically connected to a detector 2. In detail, the electrode units 12 of the sensing members 1 are electrically connected to form an input of the detector 2.

Furthermore, a limiting member 131 may be disposed on the insulator substrate 11 for facilitating subsequent detecting operation. As mentioned above, the limiting member 131 is formed with an opening to expose the reaction portion 1210 of the working electrode 121 and a portion of the reference electrode 122, and cooperates with the insulator substrate 11 to define a space for receiving the target analyte.

Then, the amperometric biosensor may be used for detection with the following steps.

Step 38: The target analyte is introduced to each of the sensing members 1, so as to bring the target analyte into contact with at least a portion (reaction portion 1210) of the working electrode 121 and at least said exposed portion of the reference electrode 122 of each of the sensing members 1.

Step 40: The detector 2 is configured to provide a predetermined voltage between the working electrode 121 and the reference electrode 122 of each of the sensing members 1, so as to generate a current flowing through the target analyte introduced to each of the sensing members 1.

Step 42: The detector 2 is configured to detect the currents generated in step 40 for subsequent concentration analysis of the target analyte.

In the following exemplary experiment, which used the amperometric biosensor of this invention to detect concentration of uric acid, urate oxidase (available from Sigma, with a purity of 5.2 unit/mg) served as the biorecognition element for detecting uric acid, uric acid with a purity of 99% (available from Sigma) was used to prepare the target analyte with different concentrations, screen printed electrodes TE100 (available from Zensor), which include the insulator substrate 11 and the electrode unit 12, were used to manufacture the sensing members 1, and an electrochemical analyzer (CHI627C, available from CH Instruments, USA) was used as the detector 2.

In the experiment, a plurality of universal serial bus (USB) connectors were electrically interconnected using a coaxial cable, such that when the sensing members 1 are respectively inserted into the USB connectors, the sensing members 1 are electrically connected in parallel, and the sensing members 1 are coupled to the detector 2 through the USB connectors and the coaxial cable. The coaxial cable was used to isolate external electromagnetic interference due to its multi-layer structure, so as to promote precision of the measurement result.

The urate oxidase, which is reactive to the uric acid, was disposed on the reaction portion 1210 of the working electrode 121 of each sensing member 1. In detail, 4 μL of glutaraldehyde with a concentration of 2.5% was disposed on the reaction portion 1210 of the working electrode 121 under an environment of 4° C. for 1 hour, followed by disposing 4 μL of the urate oxidase solution with a concentration of 0.5 unit/mg on the electrode surface with the glutaraldehyde. Then, 4 μL of bovine serum albumin (BSA) with a concentration of 0.1 mM was disposed on the electrode surface with the urate oxidase under an environment of 4° C. overnight to complete fixing of the urate oxidase.

In order to prepare samples of the target analyte for detection, 0.0134488 gram of the uric acid was dissolved in 100 mL of phosphate buffered saline (available from GeneMark) with pH 6.75 to obtain a uric acid solution with a concentration of 0.8 mM. Then, the uric acid solution was diluted to obtain samples of the uric acid solution with concentrations of 0.1 mM, 0.2 mM and 0.4 mM. The samples of the uric acid solution were preserved under an environment of 4° C.

For detection of each sample of the uric acid solution, a blank test was performed first. In the blank test, 20 μL of the phosphate buffered saline were introduced to the sensing members 1, and the detector 2 was used to apply a voltage of 0.7V between the working electrode 121 and the reference electrode 122 of each sensing member 1. The detector 2 was set to have a detection sensitivity of 0.001 μA/mM and a sampling rate of 1 Hz, and the measurement was performed for 150 seconds to obtain blank data for correction of the subsequent measurement result.

Then, 200 μl of the to-be-tested sample of the uric acid solution were introduced to each of the sensing members 1. The experiment was performed with single-sensing member configuration, dual-sensing member configuration, and triple-sensing member configuration for each concentration in order to compare differences in sensitivity, precision and SNR there among. During the sample introduction process, the detector 2 continuously applied the voltage of 0.7V until a total time period of 540 seconds. The samples of the uric acid solution with different concentrations (0.1 mM, 0.2 mM, 0.4 mM and 0.8 mM) were tested respectively.

The urate oxidase reacts with the uric acid to generate allantoin, carbon dioxide and hydrogen peroxide. Oxidation current is generated by application of a certain voltage to the hydrogen peroxide, and the magnitude of the oxidation current is associated with concentration of the uric acid. Therefore, the concentration of the uric acid may be derived from the magnitude of the oxidation current.

In the experiment, the voltage of 0.7V was used to generate the oxidation current. The concentration of the uric acid in a normal human body ranges between 0.13 mM and 0.46 mM, and the concentrations of the uric acid used in this experiment (0.1 mM, 0.2 mM, 0.4 mM and 0.8 mM) cover this range.

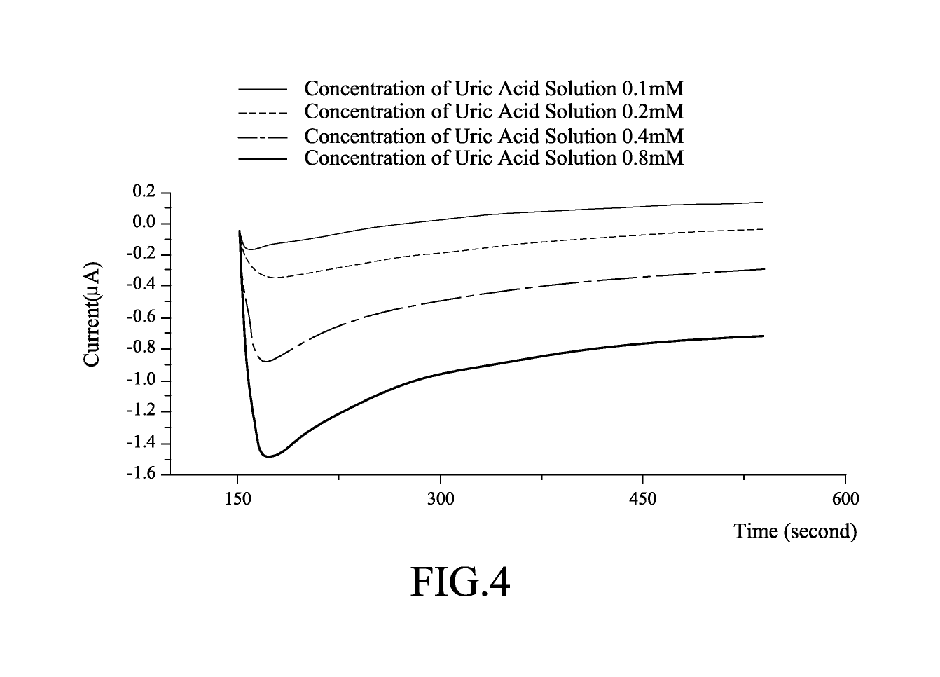

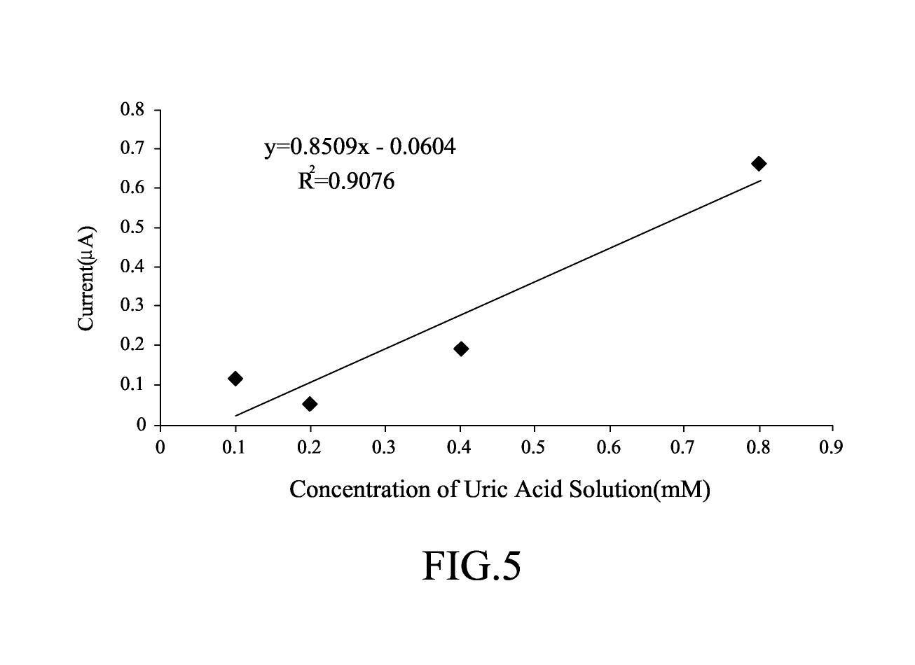

FIG. 4 is a plot showing a current measurement result using only one sensing member (single-sensing configuration). It is evident from this figure that a higher concentration of the uric acid results in greater current variation, and the reaction of the urate oxidase and the uric acid achieved chemical equilibrium at the 450^{th} second. Therefore, a current value at the 450^{th} second is used to serve as a steady state current value for the subsequent analysis. Referring to FIG. 5, there is a linear relationship between the steady state current value and the concentration of the uric acid, and a coefficient of determination R² is 0.9076.

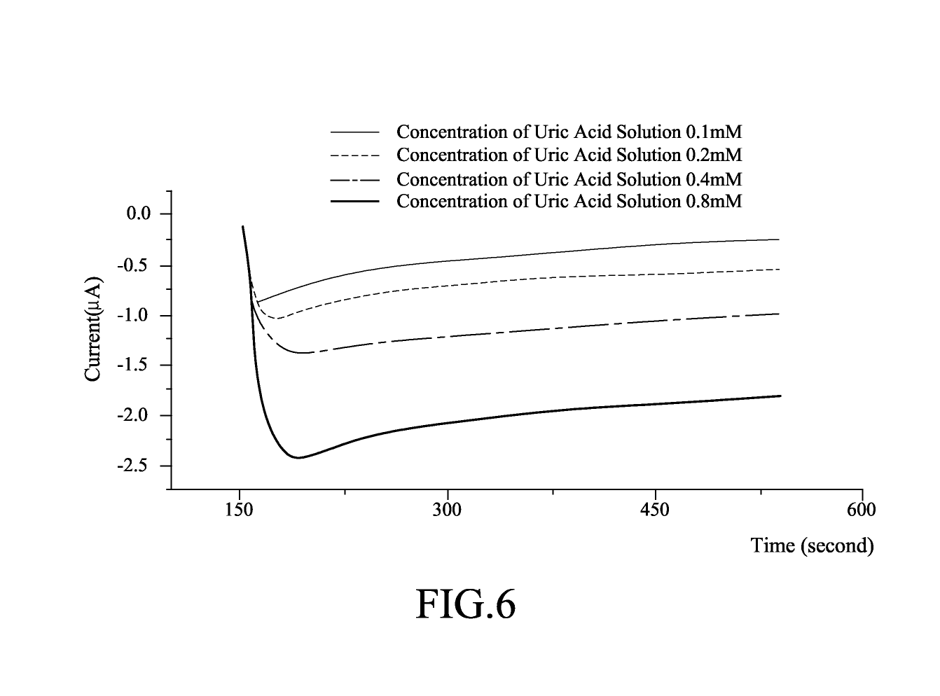

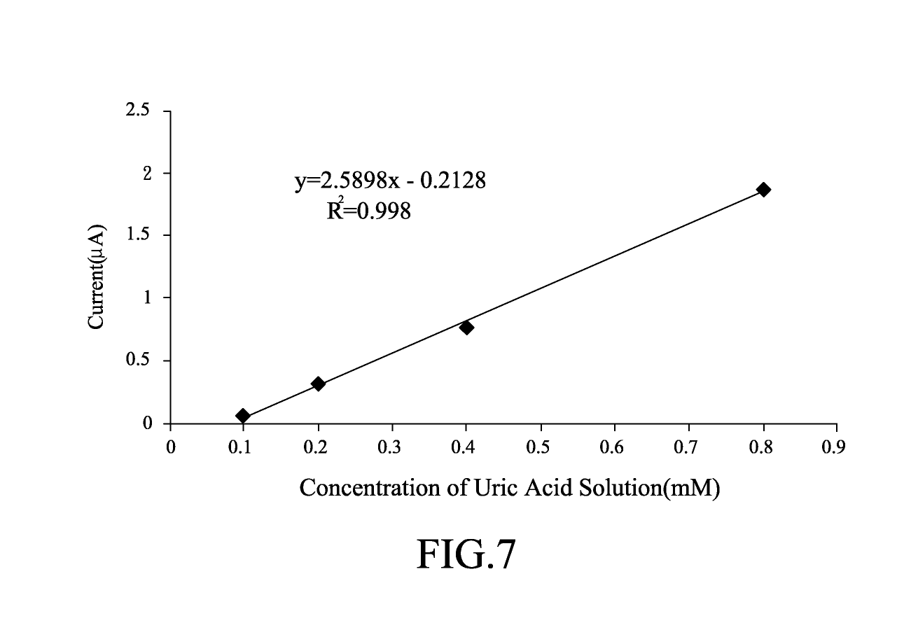

FIG. 6 is a plot showing a current measurement result using two sensing members (dual-sensing configuration). The plot also shows a trend that a higher concentration of the uric acid results in greater current variation. However, the current obtained using dual-sensing configuration is higher than that obtained using single-sensing configuration. Referring to FIG. 7, there is also a linear relationship between the steady state current value and the concentration of the uric acid, and a coefficient of determination R² is 0.9980. Compared to single-sensing configuration, parallel connected sensing members 1 result in higher precision and better linearity.

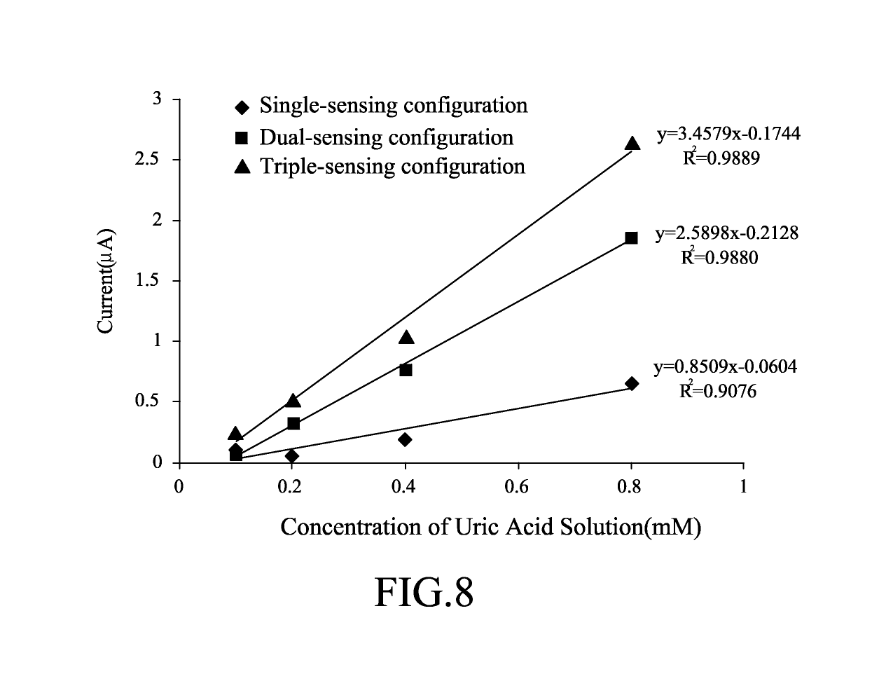

FIG. 8 is a plot to compare current measurements using single-sensing configuration and the preferred embodiment used in dual-sensing configuration and triple-sensing configuration (three sensing members 1 are used). It is apparent from this figure that using multi-sensing configuration results in better linearity and a greater slope than those when single-sensing configuration is in use, which means that the preferred embodiment used in multi-sensing configuration has higher precision and higher sensitivity.

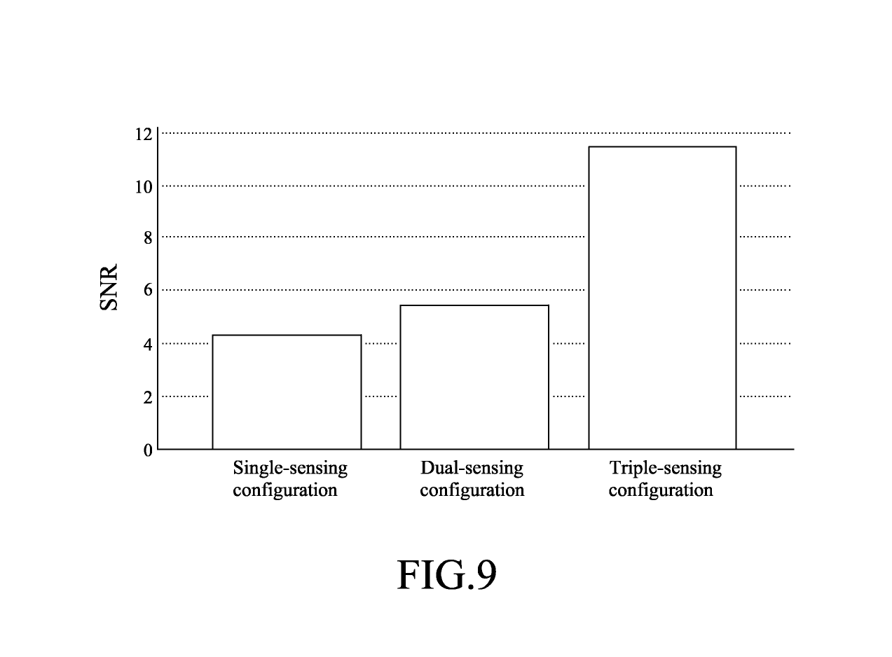

FIG. 9 is a histogram showing differences of SNRs between measurements using single-sensing configuration and using multi-sensing configuration. The data used in this figure were obtained using the sample of the uric acid solution with the concentration of 0.8 mM. It is apparent from this figure that using multi-sensing configuration results in higher SNR than that when the single-sensing configuration is in use. Use of multi-sensing configuration promotes signal strength and sensitivity of the amperometric biosensor.

To sum up, the amperometric biosensor of this invention electrically connects the sensing members 1 to promote SNR, so that concentration of the target analyte may be derived from current variation with high precision within a short amount of time. Furthermore, the present invention uses screen printed electrodes to manufacture the sensing member 1 with a low cost and a small size, so that the user may perform self-detection at home.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An amperometric biosensor for detecting concentration of a target analyte, said amperometric biosensor comprising a detector and a plurality of sensing members that are connected electrically to form an input of said detector,
each of said sensing members including an insulator substrate and an electrode unit disposed on said insulator substrate,
said electrode unit including a working electrode with a biorecognition element disposed thereon for reaction with the target analyte, and a reference electrode spaced apart from said working electrode,
each of said sensing members being adapted to receive the target analyte, so as to bring the target analyte into contact with at least a portion of said working electrode and at least a portion of said reference electrode;
said detector being configured to provide said working electrode and said reference electrode of each of said sensing members with a predetermined voltage therebetween, so as to generate a current that flows through the target analyte received by each of said sensing members;
said detector being further configured to detect the currents generated by said sensing members for subsequent concentration analysis of the target analyte.

2. The amperometric biosensor as claimed in claim 1, wherein said biorecognition element is an enzyme reactive to the target analyte.

3. The amperometric biosensor as claimed in claim 1, wherein each of said sensing members further includes a limiting member that is disposed on said insulator substrate, that is formed with an opening to expose said portion of said working electrode and said portion of said reference electrode, and that cooperates with said insulator substrate to define a space for receiving the target analyte.

4. The amperometric biosensor as claimed in claim 3, wherein said limiting member is made of an insulating material.

5. The amperometric biosensor as claimed in claim 1, wherein said working electrode of each of said sensing members is made of a carbonic material.

6. The amperometric biosensor as claimed in claim 1, wherein said reference electrode of each of said sensing members is an Ag/AgCl electrode.

7. The amperometric biosensor as claimed in claim 1, wherein said working electrode of each of said sensing members further has a cross-linking agent disposed thereon for linkage between said biorecognition element and a surface of said working electrode.

8. The amperometric biosensor as claimed in claim 7, wherein said cross-linking agent is glutaraldehyde.

9. The amperometric biosensor as claimed in claim 1, wherein said working electrodes of said electrode units of said sensing members are electrically interconnected, and said reference electrodes of said electrode units of said sensing members are electrically interconnected.

10. The amperometric biosensor as claimed in claim 1, wherein each of said sensing members further includes a blocking member disposed on said insulator substrate in a manner that said portion of said reference electrode is not covered thereby and that said blocking member surrounds said portion of said working electrode, said blocking member being formed with an opening that exposes said portion of said working electrode.

11. The amperometric biosensor as claimed in claim 1, wherein said electrode unit further includes a counter electrode coupled to said working electrode for stabilization of an electrical potential at said working electrode.

12. A method for manufacturing an amperometric biosensor for sensing concentration of a target analyte, comprising:
a) providing a plurality of insulator substrates each having an electrode unit disposed thereon, wherein the electrode unit includes a working electrode and a reference electrode spaced apart from the working electrode;
b) disposing a blocking member on each of the insulator substrates in a manner that the reference electrode is not covered thereby and that the blocking member surrounds a portion of the working electrode, the blocking member being formed with an opening that exposes said portion of the working electrode, and cooperating with the insulator substrate to define a space;
c) introducing a biorecognition element that is reactive to the target analyte into the space defined in step b), so as to dispose the biorecognition element on a surface of said portion of the working electrode that is exposed from the opening of the blocking member; and
d) connecting electrically the electrode units to each other.

13. The method as claimed in claim 12, wherein the biorecognition element is an enzyme.

14. The method as claimed in claim 12, further comprising, prior to step c), introducing a cross-linking agent into the space defined in step b) for linkage between a surface of the working electrode and the biorecognition element.

15. The method as claimed in claim 14, wherein the cross-linking agent includes glutaraldehyde.

16. The method as claimed in claim 12, further comprising: disposing a limiting member on each of the insulator substrates, the limiting member having an opening that exposes the portion of the working electrode and a portion of the reference electrode, and cooperating with the insulator substrate to define a space for receiving the target analyte.

17. A method for detecting concentration of a target analyte, comprising:
a) connecting electrically a plurality of sensing members to form an input of a detector, wherein each of the sensing members includes an insulator substrate and an electrode unit disposed on the insulator substrate, the electrode unit including a working electrode with a biorecognition element disposed thereon for reaction with the target analyte, and a reference electrode spaced apart from the working electrode;
b) introducing the target analyte to each of the sensing members, so as to bring the target analyte into contact with at least a portion of the working electrode and at least a portion of the reference electrode of each of the sensing members;
c) configuring the detector to provide a predetermined voltage between the working electrode and the reference electrode of each of the sensing members, so as to generate a current flowing through the target analyte introduced to each of the sensing members; and
d) configuring the detector to detect the currents generated in step c) for subsequent concentration analysis of the target analyte.

18. The method as claimed in claim 17, wherein, in step a), the working electrodes of the electrode units of the sensing members are electrically interconnected, and the reference electrodes of the electrode units of the sensing members are electrically interconnected.

19. The method as claimed in claim 17, further comprising, prior to step b), disposing, on each of the sensing members, a limiting member on the insulator substrate, the limiting member having an opening that exposes the portion of the working electrode and the portion of the reference electrode, and cooperating with the insulator substrate to define a space for receiving the target analyte.
